(19) United States
(12) Patent Application Publication
(10) Pub. No.: US 2016/0037120 A1
(43) Pub. Date: Feb. 4, 2016

(54) Camcorder/MP3 Plug-in DVR/TiVo

(71) Applicant: Michael Lewis Moravitz, Fairfax, VA (US)

(72) Inventor: Michael Lewis Moravitz, Fairfax, VA (US)

(21) Appl. No.: 14/756,732

(22) Filed: Oct. 6, 2015

(51) Int. Cl. H04N 5/765; H04N 21/4147

(52) U.S. Cl. CPC H04N 5/765; H04N 21/4147

(57) ABSTRACT

Patent for Engineering DVR or TiVo Box to Have Cable Receptacle for Camcorder or MP3 Player for Storing and Playing of Video or Sound.

Camcorders and MP3 players should be able to connect to the storage systems of DVRs or TiVo television cable and satellite boxes in order to download, store, and play video or sound.

The USB cable on MP3 players or the cables on camcorders could have inputs on the cable and satellite boxes in order to receive this digitized material. This would be a way to have home videos or video and music purchased online to be stored and used on one's television. Music videos could be readily purchased, as well as music video albums for viewing and listening through one's television. Also, music could be listened to and liner notes read on the TV screen. This would be an alternative to streaming, and would further break through problems of integration and connectivity. Engineering problems making camcorders and MP3 players compatible with cable and satellite boxes would have to be overcome, but the standardization of cables and microchip memory storage systems helps.

1. Builds on Patents for DVRs;

2. Builds on Patents for TiVo;

3. Builds on Patents for Cables for Camcorders and MP3 players.
